(19) United States
(12) Patent Application Publication
(10) Pub. No.: US 2025/0392060 A1
(43) Pub. Date: Dec. 25, 2025

(54) MULTI-CONTACT CONDUCTIVE TERMINAL OF TERMINAL BLOCK

(71) Applicants: DINKLE ENTERPRISE CO., LTD., New Taipei City (TW); DINKLE ELECTRIC MACHINERY (CHINA) CO., LTD., Kunshan City (CN); LI YANG ELECTRIC MACHINERY (DONGGUAN) CO., LTD., Dong Guan City (CN)

(72) Inventors: Xiangdong SHENG, Kunshan City (CN); Xu LI, Kunshan City (CN); Xuehou YAO, Kunshan City (CN); Zijian WANG, Kunshan City (CN); Mingshuo HUANG, Kunshan City (CN); Hao CHENG, Kunshan City (CN)

(21) Appl. No.: 18/751,060

(22) Filed: Jun. 21, 2024

(51) Int. Cl. H01R 9/24

(52) U.S. Cl. CPC H01R 9/24

(57) ABSTRACT

A conductive terminal used for electrically connecting with a wire includes a terminal body, a conductive contact wall and a wire pressing wall. The conductive contact wall is fixedly disposed on the terminal body and formed with a conductive contact surface for supporting the wire. The conductive contact surface contacts a lateral surface of the wire. The wire pressing wall is fixedly disposed on the terminal body and is capable of closely contacting another lateral surface of the wire located on the conductive contact surface. The another lateral surface and the lateral surface are opposite to each other. The contact points of the wire and the conductive terminal can be effectively added to significantly improve the current flowing ability of the terminal block after wiring and the performance stability of the terminal block to make the wiring of the wire stabler.

### BACKGROUND

### Technical Field

The disclosure relates to a connector, particularly to a multi-contact conductive terminal of terminal block.

### Related Art

The structure of a terminal block for wiring is to form a conductive contact surface 21 on the conductive terminal as shown in FIGS. 1-3. A rigid stranded wire 8 is jointly clamped by the elastic force of the elastic sheet S with a hanging arm structure and the conductive contact surface 21. Because the rigid stranded wire 8 is impossible to be an absolutely flat and straight structure that is parallel to the conductive contact surface 21 of the conductive terminal, there are at most two contact points, even only one contact point (as shown in FIG. 1, a first contact point 81 and a second contact point 82 exist between the wire 8 and the conductive contact surface 21) when the rigid stranded wire 8 is in contact with the conductive contact surface 21 with a planar shape. This results in poor current flowing ability and poor stability of wiring performance after wiring.

### SUMMARY

An object of the disclosure is to provide a multi-contact conductive terminal of terminal block, which can effectively increase contact points of the conductive terminal and a wire to improve the current conduction ability of a terminal block after wiring and the stability of performance of a terminal block.

To accomplish the above object, the disclosure provides a multi-contact conductive terminal of terminal block used for electrically connecting with a wire. The conductive terminal includes a terminal body, a conductive contact wall and a wire pressing wall. The conductive contact wall is fixedly disposed on the terminal body and formed with a conductive contact surface for supporting the wire. The conductive contact surface contacts a lateral surface of the wire. The wire pressing wall is fixedly disposed on the terminal body and is capable of closely contacting another lateral surface of the wire located on the conductive contact surface. The another lateral surface and the lateral surface are opposite to each other.

As a further improvement of the disclosure, the wire pressing wall is formed with a slant wire pressing surface, an acute angle is formed between the slant wire pressing surface and the conductive contact surface, a wiring channel is formed between the slant wire pressing surface and the conductive contact surface, the wiring channel comprises a wire input end and a wire output end, the wiring channel is formed to be of a flaring shape by a gap of the wire input end being greater than a gap of the wire output end, the gap of the wire output end is less than or equal to a diameter of the wire, and the gap of the wire input end is greater than the diameter of the wire.

As a further improvement of the disclosure, the wire pressing wall and the conductive contact wall are bent sheets disposed on the terminal body at an interval.

As a further improvement of the disclosure, a first bent portion is formed between the terminal body and the conductive contact wall, and a second bent portion is formed between the terminal body and the wire pressing wall.

As a further improvement of the disclosure, the terminal body is extended with a lateral protrusion, the lateral protrusion comprises a slope slanting relative to the conductive contact wall, and the wire pressing wall is connected to the slope to slant together.

As a further improvement of the disclosure, the wire pressing wall slants relative to the conductive contact wall at an interval.

In comparison with the related art, the disclosure has the following functions. The contact points of the wire and the conductive terminal can be effectively added by the contact from the wire pressing wall formed on the conductive terminal to the upper surface of the wire on the conductive contact surface, the first wire binding protrusion and the second wire binding protrusion disposed on the conductive contact surface and the support from both the first ramp on the first wire binding protrusion and the second ramp on the second wire binding protrusion to the lateral surface of the distal section of the wire along the wire feeding direction, and the pressurization from the wire pressing wall to the upper surface of the distal end of the wire, so as to significantly improve the current flowing ability of the terminal block after wiring and the performance stability of the terminal block to make the wiring of the wire stabler.

### BRIEF DESCRIPTION OF THE DRAWINGS

FIG. 1 is a wiring principle diagram of a terminal block for wiring;

FIG. 2 is a perspective view of a related-art terminal block;

FIG. 3 is a perspective view of a related-art conductive terminal;

FIG. 4 is the first perspective view of the first structure of the conductive terminal of the disclosure;

FIG. 5 is the second perspective view of the first structure of the conductive terminal of the disclosure;

FIG. 6 is a perspective view of the conductive terminal of the first structure of the disclosure;

FIG. 7 is a perspective view of the conductive terminal of the second structure of the disclosure;

FIG. 8 is a perspective view of the contact status of the wire and the conductive terminal of the second structure of the disclosure;

FIG. 9 is a front view of the contact status of the wire and the conductive terminal of the second structure of the disclosure;

FIG. 10 is a perspective view of the conductive terminal of the third structure of the disclosure;

FIG. 11 is a front view of the conductive terminal of the third structure of the disclosure;

FIG. 12 is a perspective view of the conductive terminal of the fourth structure of the disclosure;

FIG. 13 is a front view of the conductive terminal of the fourth structure of the disclosure;

FIG. 14 is a perspective view of the contact status of the wire and the conductive terminal of the fourth structure of the disclosure;

FIG. 15 is a front view of the contact status of the wire and the conductive terminal of the fourth structure of the disclosure;

FIG. 16 is an exploded view of the conductive terminal (the fifth structure), the elastic sheet and the wire of the disclosure;

FIG. 17 is a perspective view of the contact status of the conductive terminal (the fifth structure), the elastic sheet and the wire of the disclosure; and

FIG. 18 is a cross-sectional view of the contact status of the conductive terminal (the fifth structure), the elastic sheet and the wire of the disclosure.

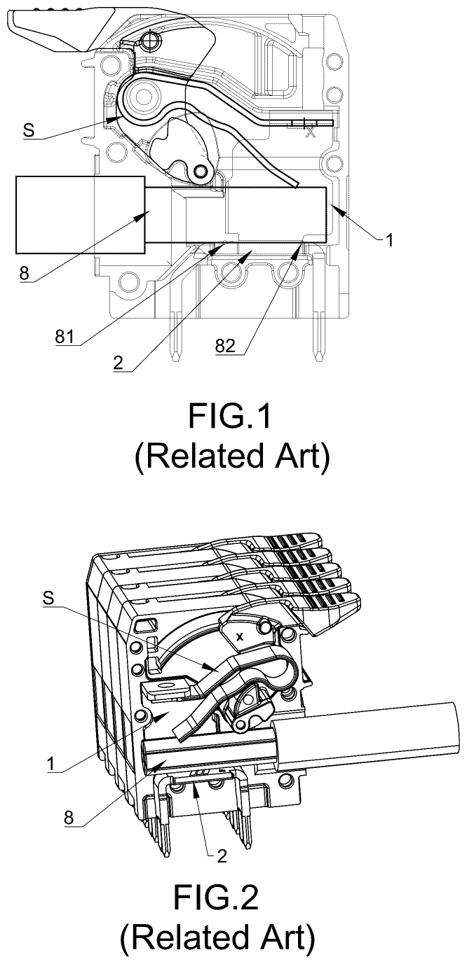

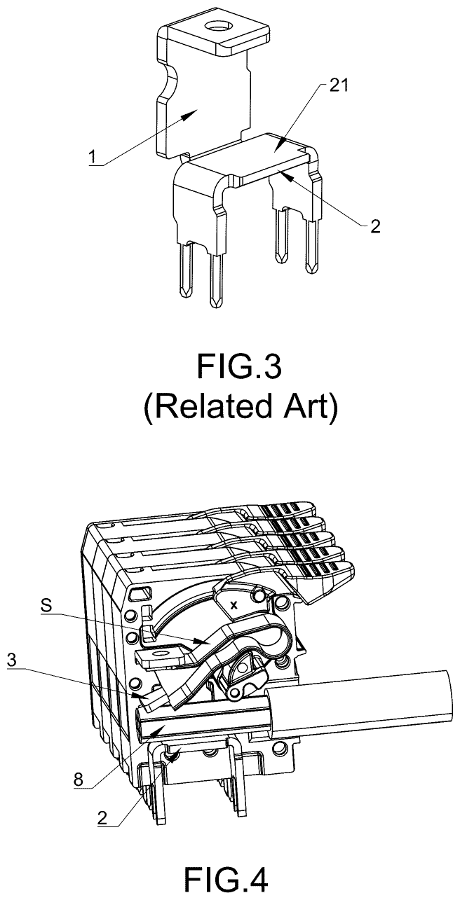

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

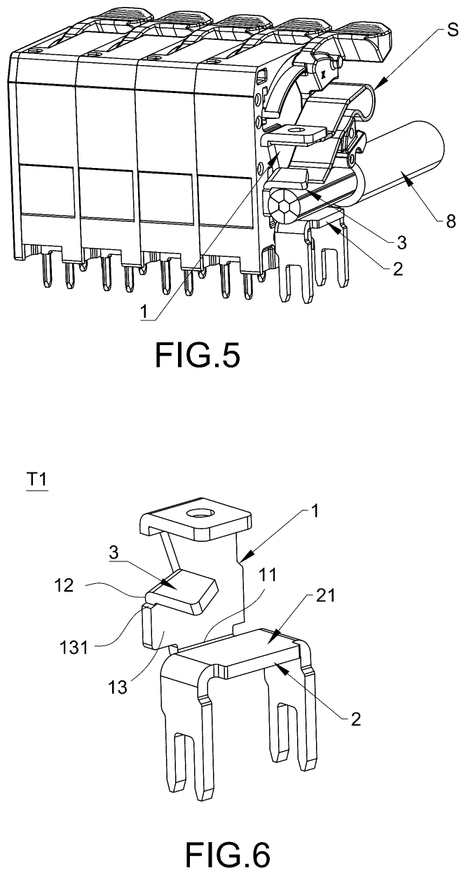

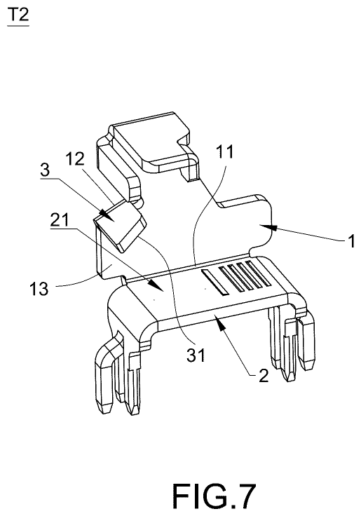

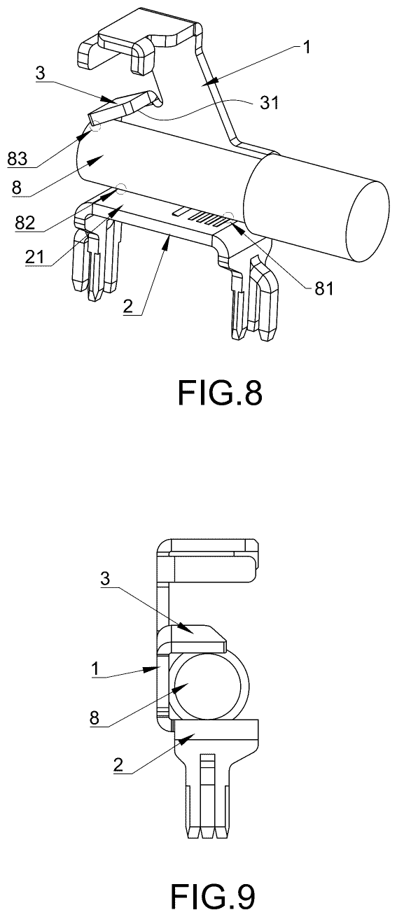

As shown in FIGS. 4-9, the disclosure provides a multi-contact conductive terminal of terminal block, used for electrically connecting with a wire 8. The multi-contact conductive terminal (hereinafter “conductive terminal) T1, T2 includes a terminal body 1 and a conductive contact wall 2. The conductive contact wall 2 is fixedly disposed on the terminal body 1 and is formed with a conductive contact surface 21 for supporting the wire 8. The terminal body 1 is defined with a wire feeding direction and a transverse direction perpendicular to the wire feeding direction (all not shown in the figures). A side of the wire 8, which is in contact with the conductive contact surface 21, is referred to as the lower side. The terminal body 1 is further disposed with a wire pressing wall 3. The wire pressing wall 3 can closely contact a surface of the upper side of the wire 8. After the wire 8 is inserted into the terminal block through the wiring hole of the terminal block for wiring, the wire 8 is slidingly inserted into the terminal block along the conductive contact surface 21 of the conductive contact wall 2. After the wire 8 is inserted into a certain depth, the wire 8 passes through a gap between the wire pressing wall 3 and the conductive contact surface 21 and the wire pressing wall 3 is in close contact with the surface of the upper side of the wire 8. Thus, after the wire 8 is clamped by the elastic sheet S inside the terminal block on the conductive contact surface 21, the contact points between the wire 8 and the conductive terminal T1, T2 are at least three in number, and as shown in FIG. 8, they are a first contact point 81 which is directly opposite to a portion of the wire 8 clamped by the elastic sheet S, a second contact point 82 which is directly opposite to a portion of the wire 8 clamped between the conductive contact surface 21 and the wire pressing wall 3 and a third contact point 83 which is a portion of the wire 8 contacted with the wire pressing wall 3. This effectively increases the amount of contact points of the wire 8 and the conductive terminal T1, T2, guarantees the stability of signal transmission of the terminal block for wiring and effectively improves the current flowing ability of the terminal block to implement large-current transmission.

The wire pressing wall 3 is formed with a slant wire pressing surface 31 at an acute angle with the conductive contact surface 21. The gap of the wire input end between the slant wire pressing surface 31 and the conductive contact surface 21 is greater than the flaring wiring channel of the gap of the wire output end, and the gap of the wire output end of the flaring wiring channel is less than or equal to the diameter of the wire 8. The gap of the wire input end of the flaring wiring channel is greater than the diameter of the wire 8. The slant wire pressing surface 31 of the wire pressing wall 3 makes a flare structure formed between the slant wire pressing surface 31 and conductive contact surface 21 to implement insertion guiding to the wire 8, so that the wire 8 can be smoothly inserted into the gap between the slant wire pressing surface 31 and the conductive contact surface 21 and can smoothly pass through the directly opposite position of the wire pressing wall 3 and the conductive contact wall 2 to make both the slant wire pressing surface 31 and conductive contact surface 21 able to be in close contact with the wire 8. In addition, the wire pressing wall 3 may also be designed into a convex arcuate surface or a cylindrical structure. These are embodiments easy to be imagined by those skilled in the art and belong to the protection scope of the disclosure.

The wire pressing wall 3 and the conductive contact wall 2 are bent sheets disposed on the terminal body 1 at an interval. In detail, a first bent portion 11 is formed between the terminal body 1 and the conductive contact wall 2, and a second bent portion 12 is formed between the terminal body 1 and the wire pressing wall 3. The conductive contact wall 2 is bent relative to the terminal body 1 through the first bent portion 11, and the wire pressing wall 3 is bent relative to the terminal body 1 through the second bent portion 12. The terminal body 1 is formed with the wire pressing wall 3 and the conductive contact wall 2 through bending to make the overall structure of the conductive terminal T1, T2 simple to be easy to be manufactured. The wire pressing wall 3 may also be formed with a vee elastic sheet structure through bending to implement close contact insertion avoidance to the wire 8.

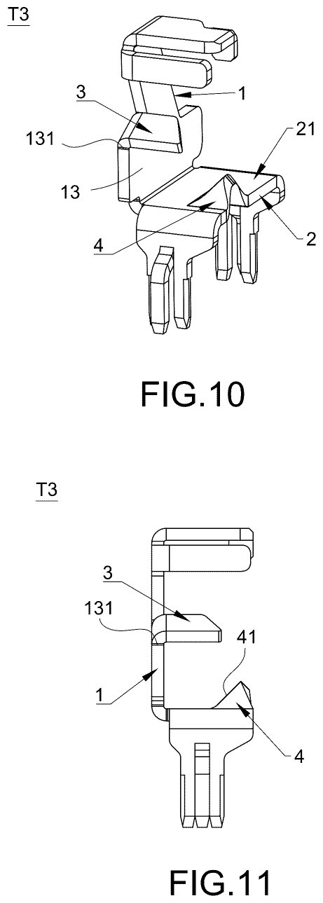

In addition, as shown in FIGS. 6-9, to indeed bend the wire pressing wall 3 relative to the terminal body 1, the terminal body 1 is extended with a lateral protrusion 13 along the wire feeding direction. The lateral protrusion 13 has a slope 131 slanting relative to the conductive contact wall 2 (or the conductive contact surface 21). The wire pressing wall is connected to the slope 131 and follows the slope 131 to slant together to form the slant wire pressing surface 31. Thus, the wire pressing wall 3 can slant relative to the conductive contact wall 2 (or the conductive contact surface 21) and keep an interval from each other as shown in the figures. In the conductive terminal T3 shown in FIGS. 10 and 11, the conductive contact surface 21 is disposed with a first wire binding protrusion 4. The wire 8 on the conductive contact surface 21 is accommodated between the first wire binding protrusion 4 and the terminal body 1. A sidewall of the first wire binding protrusion 4, which faces the terminal body 1, is formed with a first ramp 41. An obtuse angle is formed between the first ramp 41 and the conductive contact surface 21. The circumferential outer surface of the wire 8 has two portions which are in close contact with the terminal body 1 and the first ramp 41 separately. The circumferential outer surface of the wire 8 is always in contact with both the terminal body 1 and the first ramp 41 by way of both the first wire binding protrusion 4 disposed on the conductive contact surface 21 and the binding of the first ramp 41 on the first wire binding protrusion 4 to the wire 8 along the width direction (or the transverse direction) of the conductive contact surface 21 so as to add two contact points, which are (as shown in FIG. 15) the fourth contact point (not labeled) of the wire 8 and the terminal body 1 and the fifth contact point 84 of the wire 8 and the first ramp 41. In some embodiments, the first wire binding protrusion 4 is disposed on the edge of a side of the conductive contact surface 21 in the width direction (or the transverse direction), which is away from the terminal body 1.

In other embodiments which are not depicted in the figures, the first wire binding protrusion 4 is configured into at least two in number. The at least two first wire binding protrusions 4 are arranged at an interval on the conductive contact surface 21 in the wire feeding direction so as to increase more contact points.

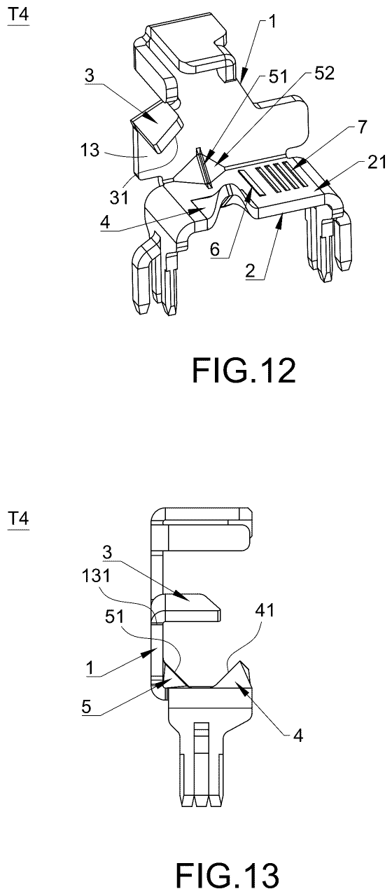

In the conductive terminal T4 shown in FIGS. 12-15, the conductive contact wall 2 (or the conductive contact surface 21) is further disposed with a second wire binding protrusion 5. The second wire binding protrusion 5 and the first wire binding protrusion 4 are arranged on the conductive contact wall 2 (or the conductive contact surface 21) at an interval along the left-right direction (or the transverse direction). A sidewall of the second wire binding protrusion 5, which faces the first wire binding protrusion 4, is formed with a second ramp 51. An obtuse angle is also formed between the second ramp 51 and the conductive contact surface 21. The wire 8 on the conductive contact surface 21 is supported on the first ramp 41 of the first wire binding protrusion 4 and the second ramp 51 of the second wire binding protrusion 5. The wire 8 is always in contact with both the first ramp 41 and the second ramp 51 by way of the vee wire supporting and binding structure jointly formed by both the second ramp 51 on the second wire binding protrusion 5 and the first ramp 41 on the first wire binding protrusion 4 so as to add two contact points, which are the fifth contact point 84 at which the wire 8 is in contact with the first ramp 41 and a sixth contact point 85 at which the wire 8 is contact with the second ramp 51. Meanwhile, this can also be advantageous to smoothly inserting the wire 8 between the first ramp 41 and the second ramp 51. In some embodiments, the second wire binding protrusion 5 is disposed at the joint of the conductive contact surface 21 and the terminal body 1.

As a result, the contact points of the wire 8 and the conductive terminal T4 can be effectively added by the contact from the wire pressing wall 3 formed on the conductive terminal T4 to the upper surface of the wire 8 on the conductive contact surface 21, the first wire binding protrusion 4 and the second wire binding protrusion 5 disposed on the conductive contact surface 21 and the support from both the first ramp 41 on the first wire binding protrusion 4 and the second ramp 51 on the second wire binding protrusion 5 to the lateral surface of the distal section of the wire 8 along the wire feeding direction, and the pressurization from the wire pressing wall 3 to the upper surface of the distal end of the wire 8, so as to significantly improve the current flowing ability of the terminal block after wiring and the performance stability of the terminal block to make the wiring of the wire 8 stabler.

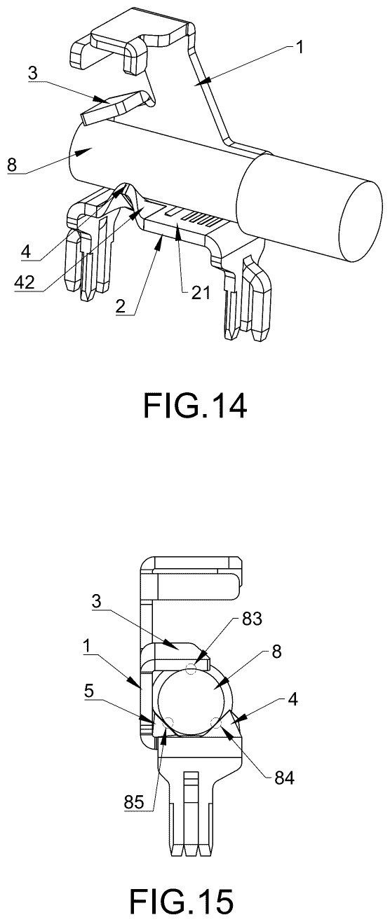

The contact points of both the first ramp 41 and the second ramp 51 and the wire 8 are located on the same cross-section of the wire 8. The contact point of the wire pressing wall 3 and the wire 8 is closer to the end portion of the wire 8 along the wire feeding direction than the contact points of both the first ramp 41 and the second ramp 51 and the wire 8 (as shown in FIG. 14). The wire 8 is inserted into the vee wire supporting and binding structure between the second ramp 51 and the first ramp 41 first, then runs forward a little further, enters the gap between the conductive contact surface 21 and the wire pressing wall 3 after leaving the vee wire supporting and binding structure, and is tightly pressed finally, so that there is no interference and the resistance is low during the process of inserting the wire 8. Of course, these contact points may also be designed on the same cross-section.

The wire input side of the first wire binding protrusion 4 along the wire feeding direction is a third ramp 42. The wire input side of the second wire binding protrusion 5 along the wire feeding direction is a fourth ramp 52. A gap along the wire feeding direction is formed between the third ramp 42 and the fourth ramp 52, which tapers off to form a flaring wire input structure. By the flaring wire input structure formed by the third ramp 42 and the fourth ramp 52, the wire 8 can be smoothly inserted between the first wire binding protrusion 4 and the second wire binding protrusion 5 without interference during the insertion process.

Each of the first wire binding protrusion 4 and the second wire binding protrusion 5 is a vee bump structure formed on the conductive contact wall 2 by stretching. By the first wire binding protrusion 4 and the second wire binding protrusion 5 formed on the conductive contact wall 2 by stretching, the structure is simple to be easy to be produced and manufactured.

The terminal body 1 is defined with an inserting end for being inserted by the wire 8 along the wire feeding direction. The wire pressing wall 3, the first wire binding protrusion 4 and the second wire binding protrusion 5 are all located on the conductive contact surface 21 near the inserting end at which the wire 8 is inserted along the wire feeding direction, so as to advantageous to fast insertion of the front section of the wire 8 without interfering with clamping the wire 8 of the elastic sheet S.

The conductive contact surface 21 is further disposed with a zigzag protrusive block 6 and multiple concave-convex anti-slip structures 7 arranged along the wire feeding direction at intervals. The zigzag protrusive block 6 and the concave-convex anti-slip structures 7 may increase the pulling force of the wire 8 to prevent the wire 8 from being pulled out by an external force.

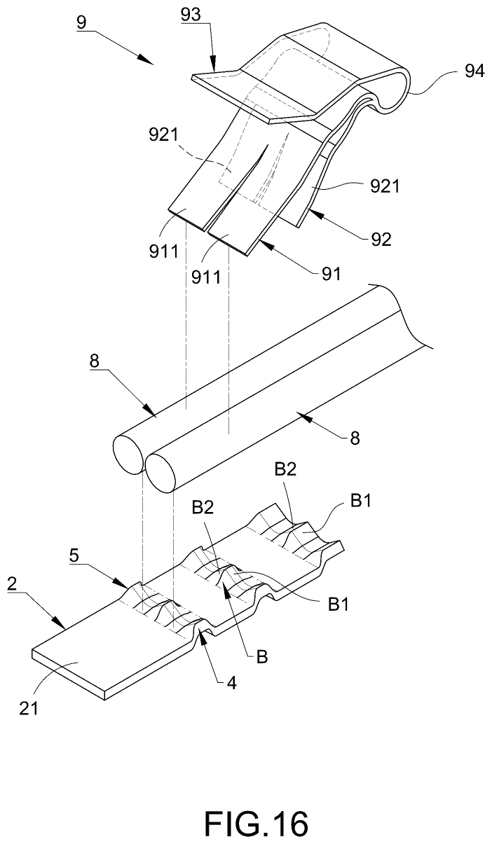

As shown in FIGS. 16-18, the conductive contact wall 2 (or the conductive contact surface 21) is further disposed with a third wire binding protrusion B located between the first wire binding protrusion 4 and the second wire binding protrusion 5. The first wire binding protrusion 4, the second wire binding protrusion 5 and the third wire binding protrusion B jointly constitute a wire binding protrusion set (not labeled). The wire binding protrusion set is configured into at least two or three in number on the conductive contact wall 2 (or the conductive contact surface 21) (the wire binding protrusion sets shown in FIG. 16 appear to be three). The at least three wire binding protrusion sets are arranged on the conductive contact surface 21 along the wire feeding direction at intervals. In detail, the first wire binding protrusion 4, the second wire binding protrusion 5 and the third wire binding protrusion B of each wire binding protrusion set are arranged on the conductive contact wall 2 (or the conductive contact surface 21) along the transverse direction at intervals. A side of the third wire binding protrusion B, which is toward the first wire binding protrusion 4, forms a first corresponding ramp B1. A side of the third wire binding protrusion B, which is toward the second wire binding protrusion 5, forms a second corresponding ramp B2. Each of the first corresponding ramp B1 and the second corresponding ramp B2 separately forms an obtuse angle with the conductive contact surface 21.

As a result, when the wire 8 is two in number, one of the wires 8 on the conductive contact surface 21 is supported by both the first ramp 41 of the first wire binding protrusion 4 and the first corresponding ramp B1 of the third wire binding protrusion B. The other wire 8 on the conductive contact surface 21 is supported by both the second ramp 51 of the second wire binding protrusion 5 and the second corresponding ramp B2 of the third wire binding protrusion B. Thus, even if two wires 8 are supported by the conductive contact surface 21, it is still the same as the condition of supporting one wire 8, which has the same amount of contact points.

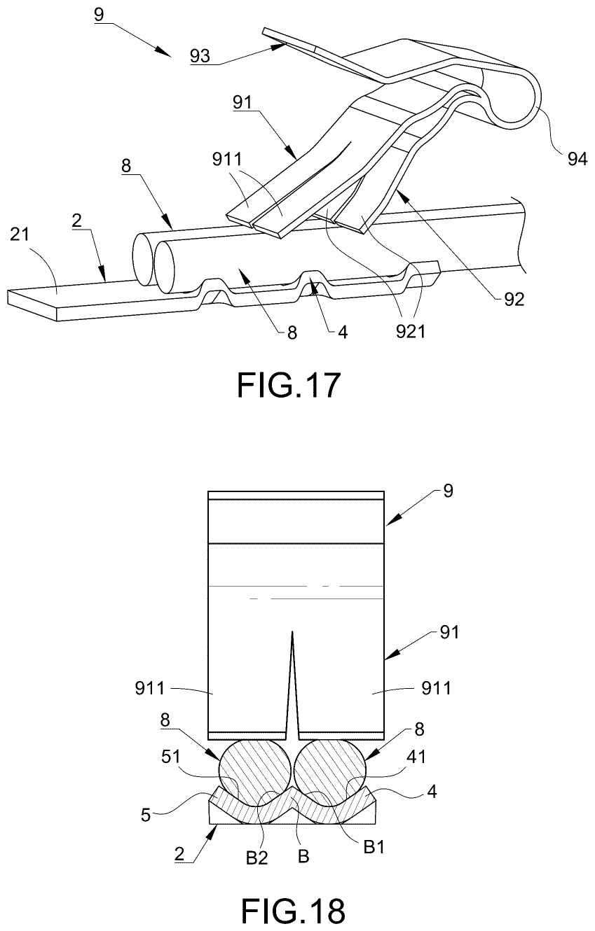

To match with the conductive contact wall 2 with multiple wire binding protrusions, a corresponding elastic sheet 9 is designed. The elastic sheet 9 includes a support portion 93, an elastic sheet bend portion 94 and at least two pressing portions. The elastic sheet bend portion 94 is connected between the support portion 93 and the at least two pressing portions. The support portion 93 is connected to part of the elastic sheet bend portion 94. The at least two pressing portions are all connected to another part of the elastic sheet bend portion 94. The at least two pressing portions include a first pressing portion 91 and a second pressing portion 92. The support portion 93 and all pressing portions separately are supported between the conductive terminal and all wires 8. The first pressing portion 91 and the second pressing portion 92 may press any part of the wire 8. In the embodiment, as shown in FIG. 17, the first pressing portion 91 and the second pressing portion 92 separately press the wire 8 with corresponding to each position between any adjacent two wire binding protrusion sets, especially, the upper surface of the wire 8 is pressed. As a result, the amount of the contact points between the wire 8 and the conductive contact surface 21 can be guaranteed to be the same as the abovementioned amount.

In detail, the first pressing portion 91 has two pressing arms 911, and the second pressing portion 92 has two pressing arms 921, too. The two first pressing arms 911 of the first pressing portion 91 separately press the two wires 8 supported on the conductive contact surface 21, and the two second pressing arms 921 of the second pressing portion 92 also separately press the two wires 8 supported on the conductive contact surface 21, so that the elastic sheet 9 indeed presses each wire 8.

In other unshown embodiments, when there is only one wire 8 and there are at least two vee wire supporting and binding structures, the first pressing portion 91 and the second pressing portion 92 of the elastic sheet 9 will have only one pressing arm 911, 921 correspondingly so as to make the pressing arm 911 of the first pressing portion 91 and the pressing arm 921 of the second pressing portion 92 separately press the wire 8 with corresponding to each position between any adjacent two vee wire supporting and binding structures.

While this disclosure has been described by means of specific embodiments, numerous modifications and variations could be made thereto by those skilled in the art without departing from the scope and spirit of this disclosure set forth in the claims.

What is claimed is:

1. A multi-contact conductive terminal of terminal block, used for electrically connecting with a wire, characterized in that the conductive terminal comprises:
a terminal body;
a conductive contact wall, fixedly disposed on the terminal body, formed with a conductive contact surface for supporting the wire, and the conductive contact surface contacting a lateral surface of the wire; and
a wire pressing wall, fixedly disposed on the terminal body, being capable of closely contacting another lateral surface of the wire located on the conductive contact surface, and the another lateral surface and the lateral surface being opposite to each other.

2. The multi-contact conductive terminal of terminal block of claim 1, wherein the wire pressing wall is formed with a slant wire pressing surface, an acute angle is formed between the slant wire pressing surface and the conductive contact surface, a wiring channel is formed between the slant wire pressing surface and the conductive contact surface, the wiring channel comprises a wire input end and a wire output end, the wiring channel is formed to be of a flaring shape by a gap of the wire input end being greater than a gap of the wire output end, the gap of the wire output end is less than or equal to a diameter of the wire, and the gap of the wire input end is greater than the diameter of the wire.

3. The multi-contact conductive terminal of terminal block of claim 1, wherein the wire pressing wall and the conductive contact wall are bent sheets disposed on the terminal body at an interval.

4. The multi-contact conductive terminal of terminal block of claim 3, wherein a first bent portion is formed between the terminal body and the conductive contact wall, and a second bent portion is formed between the terminal body and the wire pressing wall.

5. The multi-contact conductive terminal of terminal block of claim 2, wherein the wire pressing wall and the conductive contact wall are bent sheets disposed on the terminal body at an interval.

6. The multi-contact conductive terminal of terminal block of claim 5, wherein a first bent portion is formed between the terminal body and the conductive contact wall, and a second bent portion is formed between the terminal body and the wire pressing wall.

7. The multi-contact conductive terminal of terminal block of claim 1, wherein the terminal body is extended with a lateral protrusion, the lateral protrusion comprises a slope slanting relative to the conductive contact wall, and the wire pressing wall is connected to the slope to slant together.

8. The multi-contact conductive terminal of terminal block of claim 1, wherein the wire pressing wall slants relative to the conductive contact wall at an interval.
